(19) United States
(12) Patent Application Publication
(10) Pub. No.: US 2013/0066143 A1
(43) Pub. Date: Mar. 14, 2013

(54) MICROENVIRONMENT AND METHOD OF CONVEYING USER INSTRUCTIONS

(71) Applicants: Lawrence G. Ten Eyck, Laurel, MD (US); Steven M. Falk, Laurel, MD (US)

(72) Inventors: Lawrence G. Ten Eyck, Laurel, MD (US); Steven M. Falk, Laurel, MD (US)

(73) Assignee: General Electric Company, Schenectady, NY (US)

(21) Appl. No.: 13/227,967

(22) Filed: Sep. 8, 2011

(51) Int. Cl. A61G 11/00; G09B 23/28

(52) U.S. Cl. 600/22; 434/262

(57) ABSTRACT

A method and microenvironment includes accessing a dynamic image from a computer-readable medium and displaying the dynamic image on a display device communicatively connected to the microenvironment. The dynamic image includes a representation of an action performed by a clinician with respect to the microenvironment.

### FIELD OF THE INVENTION

This disclosure relates generally to a microenvironment and a method of conveying user instructions for a microenvironment.

### BACKGROUND OF THE INVENTION

Microenvironments, such as incubators and radiant warmers, typically have complex user interface controls. Conventional microenvironments are intended for use on the order of a physician by well-trained nursing staff and other paramedical professionals. Microenvironments typically give the user a fine level of control of parameters such as temperature, humidity, and oxygen level in order to give infants with low birth weight and/or other medical issues the best possible chances for survival and proper development.

Microenvironments are intended for use by sophisticated clinicians who may need to frequently make minute adjustments to settings on the microenvironment to provide optimal patient care. Conventional microenvironments are designed for clinicians in developed countries. However, in rural and low resource care settings, such as those found in many second and third-world countries, the level of medical training of the staff may be significantly lower. As such, the clinicians in rural and low resource care settings are typically not well-versed in the various features of the microenvironment. Additionally, many times the equipment used in rural and low resource care settings is used and/or donated. As a result, the user interface controls may not be in the local language. Therefore, the clinicians may not be able to read or understand the instructions, labels, or controls associated with the microenvironment. Based on one or more or the factors listed above, and due to the fact that many conventional microenvironments have complicated user interfaces, clinicians may not be able to provide optimized care for premature infants.

Therefore, for these and other reasons, there is a need for both a microenvironment with an improved user interface and an improved method of conveying user instructions to clinicians using a microenvironment.

### BRIEF DESCRIPTION OF THE INVENTION

The above-mentioned shortcomings, disadvantages and problems are addressed herein which will be understood by reading and understanding the following specification.

In an embodiment, a microenvironment for regulating the temperature of an infant includes a bed, an enclosure at least partially disposed about the bed, and a heating assembly attached to the bed. The microenvironment includes a display screen attached to the bed and a computer-readable medium attached to the bed. The computer-readable medium is encoded with a dynamic image of a user instruction with respect to the microenvironment. The microenvironment also includes a processor communicatively connected to the computer-readable medium, where the processor is configured to display the dynamic image on the display screen in order to convey the user instruction.

In an embodiment, a method of conveying user instructions for a microenvironment includes accessing a dynamic image from a computer-readable medium and displaying the dynamic image on a display screen communicatively connected to the microenvironment, where the dynamic image includes a representation of an action performed by a clinician with respect to the microenvironment.

In an embodiment, a method of conveying user instructions for a microenvironment includes detecting that a parameter of the microenvironment is outside of a target range. The method includes selecting a dynamic image with a processor from a plurality of dynamic images stored in a computer-readable medium. The selected dynamic image includes a representation of an action to adjust a parameter back into the target range. The method also includes displaying the dynamic image on a display screen.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a microenvironment in accordance with an embodiment;

FIG. 2 is a schematic diagram illustrating a microenvironment in accordance with an embodiment;

FIG. 3 is a flow chart illustrating a method in accordance with an embodiment; and

FIG. 4 is a schematic diagram illustrating three frames of a dynamic image in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

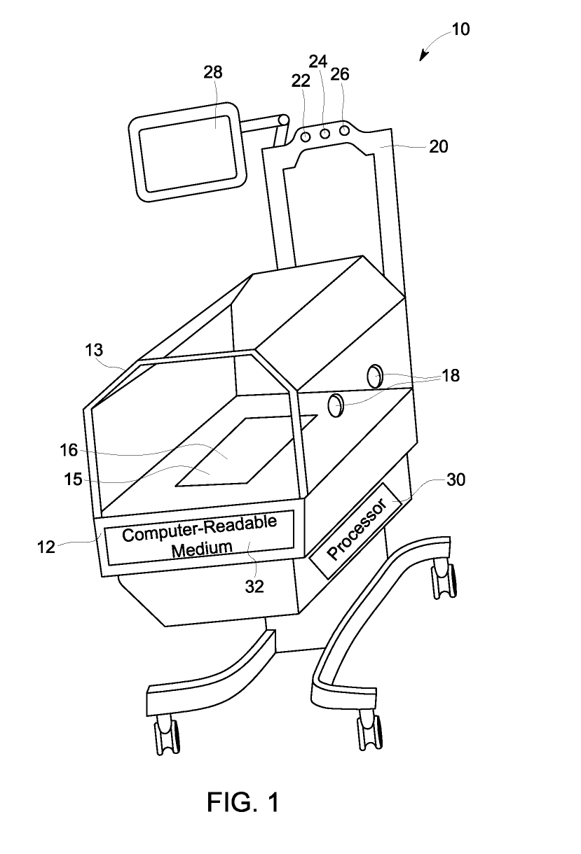

Referring to FIG. 1, a schematic representation of a microenvironment 10 is shown in accordance with an embodiment. The microenvironment 10 may be an incubator in accordance with an exemplary embodiment as shown in FIG. 1. Other embodiments may include different types of microenvironments, including different types of incubators and radiant warmers. The microenvironment 10 includes a bed 12 for receiving an infant (not shown). The bed 12 may be adjustable for height to make use of the microenvironment more comfortable for a clinician (not shown). An enclosure 13 is disposed about the bed 12. The enclosure 13 defines a portion of the microenvironment 10 adapted to receive the infant. The enclosure 13 of the embodiment shown in FIG. 1 almost completely surrounds the infant, but other embodiments may not include a complete enclosure. In other embodiments, the enclosure may include just one or more walls disposed with respect to the bed 12. Additionally, one or more of the walls of the enclosure 13 may be moveable in order to provide access for a clinician or to control the parameters within the microenvironment 10. For example, an embodiment may have four walls disposed about the bed 12, but may include an open top in order to provide access to the infant by the caregiver.

A heating assembly 15, such as a convective heater 16, is positioned beneath the surface of the bed 12. The convective heater 16 draws in ambient air, heats the ambient air with a heating coil (not shown) or other heating element and blows the heated air into the enclosure 13. The enclosure 13 includes access ports 18 through which a caregiver may easily interact with the infant while minimizing the disturbance to the controlled environment within the enclosure 13. Other types of heating assemblies including radiant heaters or a conductive heating element may be used either in place of or in addition to a convective heater such as the convective heater 16. Embodiments of the microenvironment 10 may include a circular rotating disc (not shown) on the surface of the bed 12. The rotating disc may be used to orient the infant in the optimal position for a procedure while minimizing the disturbance to the infant.

The microenvironment 10 includes a handle 20. The handle 20 may be used to push the microenvironment throughout a neonatal intensive care unit (NICU) or other settings. According to an embodiment, a plurality of controls including a temperature control 22, a humidity control 24, and a gas flow control 26 may be mounted on the handle 20. A display screen 28 may also be mounted to the handle 20. The display screen 28 may include an LCD screen, a cathode ray tube display, or any other type of screen adapted to display a pixel-based image. The display screen 28 may also be used to display data including vital signs for the infant, current conditions within the enclosure 13, and dynamic images as will be described in additional detail hereinafter.

The microenvironment 10 also includes a processor 30 communicatively connected to a computer-readable medium 32. The processor 30 is also communicatively connected to the display screen. For the purposes of the disclosure, the term communicatively connected includes both wired connections and wireless connections. The computer-readable medium 32 may be a hard drive according to an exemplary embodiment. However, the computer-readable medium 32 may include any other type of device adapted to store digital data including erasable programmable read only (EPROM), flash memory, CD-ROM, and the like.

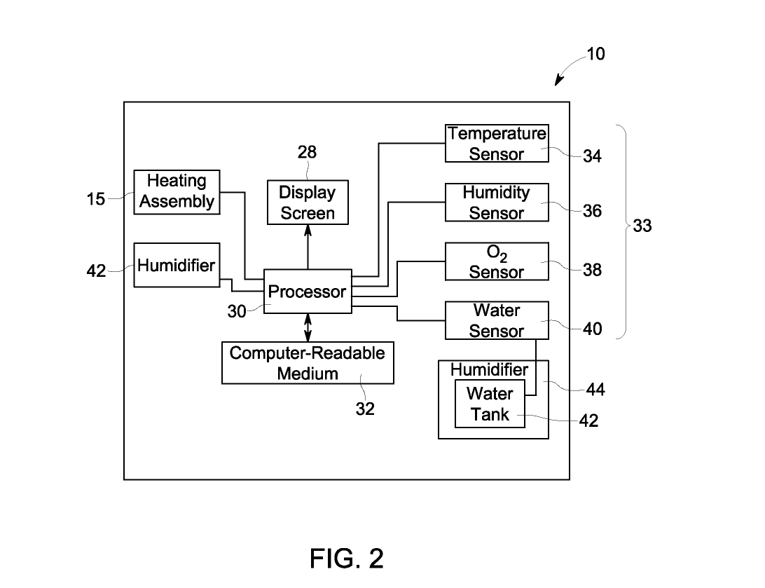

FIG. 2 is a schematic representation of a microenvironment in accordance with an embodiment. According to an embodiment, the microenvironment shown in FIG. 2 may be the same as the microenvironment 10 shown in FIG. 1. Common reference numbers will be used to identify structures that are identical between FIGS. 1 and 2.

Referring to FIG. 2, the microenvironment 10 includes the processor 30, the display screen 28, and the computer-readable medium 32 that were previously described with respect to FIG. 1. According to an embodiment, the microenvironment 10 also includes a plurality of sensors 33 communicatively connected to the processor. One or more of the sensors 33 may be configured to detect a fault, such as when a parameter is outside of a predetermined range. For example, the microenvironment may include a temperature sensor 34, a humidity sensor 36, an oxygen sensor 38, and a water sensor 40. The temperature sensor 34 may include a thermometer positioned within the enclosure 13 (shown in FIG. 1) that is adapted to detect a real-time temperature within the enclosure 13. According to an embodiment, a clinician may set a target temperature using the temperature control 22 (shown in FIG. 1). The temperature sensor 34 transmits the temperature within the enclosure 13 to the processor 30 at regular intervals. Likewise, the humidity sensor 36 may be mounted inside the enclosure 13 and it may obtain real-time samples of the humidity within the enclosure 13 of the microenvironment 10. The oxygen sensor 38 may also be mounted inside the enclosure 13 in order to monitor the real-time gas level, such as the oxygen level inside the enclosure, and transmit the oxygen level to the processor 30. The water sensor 40 may be mounted on a water tank 42 of a humidifier 44. According to an embodiment, the water sensor may detect the current water level within the water tank 42 and transmit water level data to the processor 30.

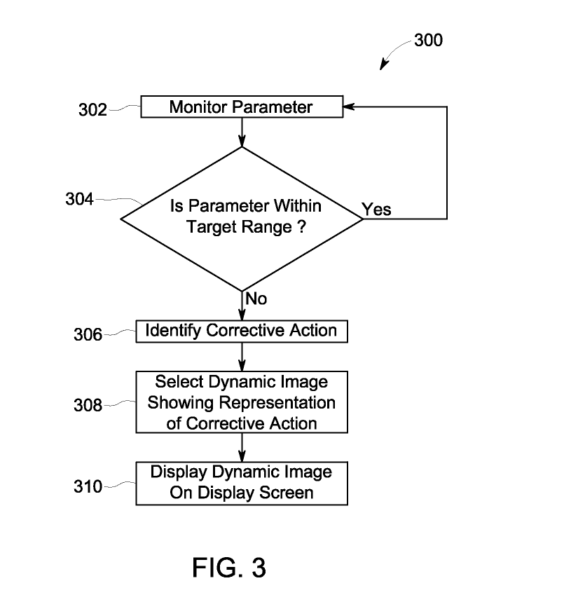

FIG. 3 is a flow chart showing a method 300 in accordance with an embodiment. Each of the blocks in the flow chart represents a step performed in accordance with an embodiment. The technical effect of the method 300 is the display of a dynamic image on a display device of a microenvironment to convey a user instruction.

Referring to FIGS. 2 and 3, at step 302, a parameter is monitored, such as by any one of the plurality of sensors 33 described with respect to FIG. 2. The method 300 will be described according to an exemplary embodiment where the parameter being monitored is water level for a humidifier. The water level may be monitored with a sensor such as water sensor 40. According to an embodiment, the water sensor 40 may transmit data to the processor 30 at predetermined sample intervals. At step 304, the processor 30 determines whether or not the parameter, in this case water level, is within a target range. If the water level is acceptable, the method 300 returns to step 302, where another sample is collected by the water sensor. However, if the water level is outside of the target range, then the method 300 proceeds to step 306. According to an embodiment, the processor 30 may be configured so that the water level is considered to be outside of the target range when the water supply in the water tank 42 of the humidifier 44 reaches a predetermined minimum level. At step 306, the processor 30 identifies a corrective action in response to the monitored parameter. According to the exemplary embodiment, the processor 30 may identify a corrective action of, “adding water to the water tank of the humidifier,” as the appropriate corrective action. Next, at step 308, the processor 30 may select a dynamic image stored on the computer-readable medium 32.

For purposes of this disclosure, the term “dynamic image” is defined to include a plurality of image frames shown in succession in order to provide the user with an image that changes in time to show motion. Video images and animated dynamic images are both examples of dynamic images. The dynamic image may be displayed on any type of display device and, for purposes of this disclosure, will be further defined to include a minimum frame rate of at least 3-5 frames per second, but preferably, at least 15 frames per second. Additionally, the animated dynamic image may include either a schematic representation of a character such as a stick figure representing a clinician, or a cartoon character performing an action. Additionally, in the case of video images, an actor may be shown performing an action with respect to a specific microenvironment.

At step 308, the processor 30 may select a dynamic image showing the corrective action identified during step 306. According to other embodiments, steps 306 and 308 may be combined into one step. For example, if there is only one dynamic image associated with a particular parameter, then the processor 30 may automatically select the dynamic image corresponding to the particular parameter that is out of the target range. So, according to the exemplary embodiment, at step 308, the processor 30 selects a dynamic image from the computer-readable medium 32 showing the process of adding water to the water tank 42. Additional details about the dynamic image showing the process of adding water will be described in detail hereinafter.

At step 310, the processor 30 displays a dynamic image on the display screen 28 (shown in FIG. 1). According to the exemplary embodiment, the dynamic image may include the process of adding water to a water tank. However, it should be appreciated that the dynamic image may include representations of many different actions according to additional embodiments.

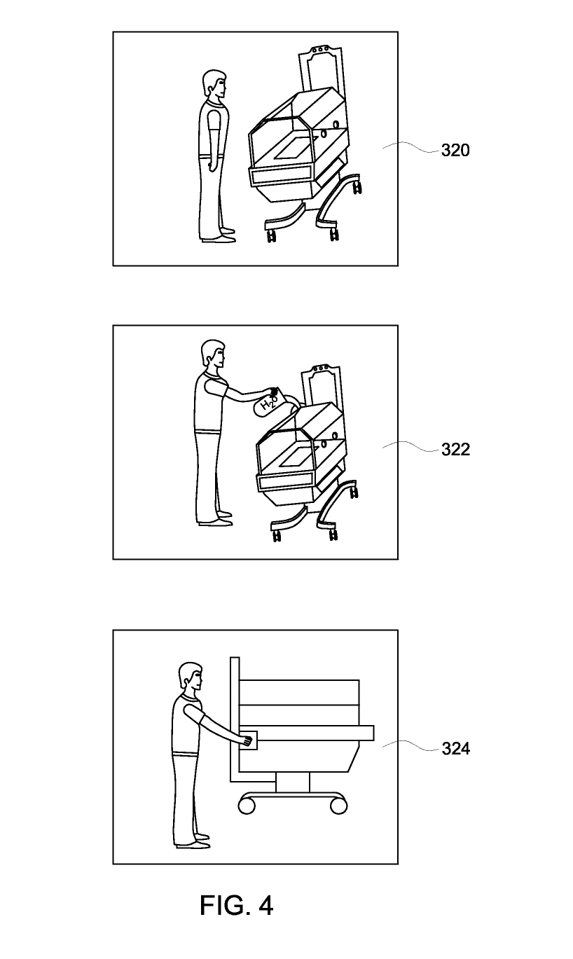

FIG. 4 is a schematic representation of several frames of a dynamic image in accordance with the exemplary embodiment. FIG. 4 includes a first image frame 320, a second image frame 322, and a third image frame 324. Referring to both FIG. 1 and FIG. 4, the first image frame 320 includes a schematic representation of a character in relation to a microenvironment such as the microenvironment 10 shown in FIG. 1. The second image frame 322 includes the schematic representation of a character pouring water into the water tank 42 of the microenvironment 10. The third image frame 234 includes a schematic representation of a character closing an access panel to the water tank. It should be appreciated that according to the exemplary embodiment, the dynamic image comprises a plurality of image frames and that FIG. 4 shows only three of those image frames. Additionally, it should be understood that the image frames of FIG. 4 are not intended to be displayed consecutively. In other words, the dynamic image may include many additional image frames in between the first, second, and third image frames (320, 322, 324) of FIG. 4. Also, the additional image frames may show the character in intermediate positions in order to provide movement that appears smooth while the dynamic image is being displayed. For example, frame rates of between 18 and 24 will typically produce smooth motion when a dynamic image is displayed, but frame rates outside this range may also be used.

Therefore, according to an embodiment, the dynamic image that is partially shown in FIG. 4 may include additional image frames showing a schematic representation of the character walking towards the microenvironment 10. The additional frames may show the character opening an access panel to gain access to the water tank. This way, it is very clear to the clinician where the access to the water tank is located on the microenvironment 10. Additionally, the additional image frames may show how refilling the water tank removes any warning light or indicator on the display screen 28.

Displaying a dynamic image such as the dynamic image described with respect to FIG. 4 to demonstrate an action is an efficient way to communicate a corrective action that needs to be performed in order to insure the best level of patient care is provided to an infant in the microenvironment. For example, unless the clinician is highly trained, he or she may not know the most appropriate corrective action to perform in response to an alarm or alert provided by the microenvironment. However, by demonstrating the corrective action by displaying a dynamic image, the clinician will be able to easily associate the proper corrective action with the current status of the microenvironment. Additionally, while an audio file stored in the computer-readable medium 32 (shown in FIG. 2) may be played during the same time while the dynamic image is displayed, the dynamic image provides enough information to allow the clinician to properly maintain and/or fine tune the environmental conditions within the microenvironment without needing to rely on sound or text. This is particularly useful when the clinicians are not fluent in the language in which the device directions are written or spoken via the audio file. While the dynamic image schematically represented in FIG. 4 shows a maintenance action, namely refilling a water tank of a humidifier, it should be appreciated that other embodiments may display dynamic images showing other actions. For example, dynamic images may show a clinician how to perform other maintenance actions. Dynamic images may also depict a representation of a user or character performing a corrective action in response to a particular alarm or alert. For example, if a certain alarm is sounding, a dynamic image may be displayed showing the clinician how to address the cause of the alarm.

According to other embodiments, dynamic images may be used to show a clinician how to adjust a parameter. For example, as described previously, one of the main goals of the microenvironment is provide an environment of the proper environmental conditions to minimize stress on an infant. For example, this often includes maintaining the temperature, humidity, and oxygen level within fairly specific bands that vary based on size and needs of a particular infant. Referring to FIG. 2, if a processor, such as processor 30, detects that the temperature of the infant is too low, the processor 30 may select an dynamic image that depicts a character performing the steps necessary by the clinician to raise the temperature within the microenvironment. This may include a dynamic image showing a character adjusting the temperature of the heating assembly 15 or the amount of air flow pushed by a blower over the heating element. Additionally, according to an embodiment, the microenvironment may be equipped with sensors that detect the position of either the walls or the top of the enclosure 13 (shown in FIG. 1). The processor 30 may select a dynamic image that shows the clinician raising one or more of the walls and or adjusting an opening in the enclosure 13 in order to minimize convective heat loss within the enclosure. It should be appreciated, that dynamic images may also be used to show the converse, that is, ways to cool the microenvironment 10 in cases where the temperature is too high.

According to another embodiment, the processor 30 (shown in FIG. 2) may display one or more dynamic images showing the clinician how to adjust a rate of gas flow if the oxygen content within the microenvironment 10 is not correct. For example, if the oxygen content is too low, the dynamic image may show a character adjusting a valve in order to increase the flow of oxygen. If the oxygen content is too high, the dynamic image may show a character adjusting a valve to decrease the flow of oxygen or to vent the enclosure 13 (shown in FIG. 2) in order to bring the oxygen content back within the desired range. According to another embodiment, the processor 30 may display one or more dynamic images showing a character adjusting the humidity within the microenvironment 10. According to another embodiment, the processor 30 may display a dynamic image showing a demonstration of how to set-up the microenvironment for use. For example, many of the components of the microenvironment 10 are adjustable or configurable. The dynamic image may include a demonstration of how to physically position the various components of the microenvironment 10. Additionally, the dynamic image may also demonstrate to the clinician the proper way to attach one or more patient monitoring sensors to the infant.

According to another embodiment, the dynamic image may include a demonstration showing how to admit an infant to the microenvironment 10. For example, the dynamic image may include a demonstration showing a user how to navigate the user interface in order to enter patient information and/or to begin using the microenvironment 10 with an infant. The dynamic image may include a demonstration of how to adjust the microenvironment 10 to provide good default parameter values. Or, the dynamic image may include a demonstration of how to select the proper parameters for a specific patient based on his or her size and weight. It should be appreciated by those skilled in the art that dynamic images may be used to show an operator or clinician how to perform tasks other than those exemplary embodiments described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A microenvironment for regulating the temperature of an infant comprising:
a bed;
an enclosure at least partially disposed about the bed;
a heating assembly attached to the bed, wherein the heating assembly is configured to provide warmth within the enclosure;
a display screen attached to the bed;
a computer-readable medium attached to the bed, the computer-readable medium encoded with a dynamic image of a user instruction with respect to the microenvironment; and
a processor communicatively connected to the computer-readable medium, wherein the processor is configured to display the dynamic image on the display screen in order to convey the user instruction.

2. The microenvironment of claim 1, further comprising a sensor communicatively connected to the processor, wherein the sensor is adapted to detect a fault.

3. The microenvironment of claim 2, wherein the sensor comprises a temperature sensor, a humidity sensor, an oxygen sensor, or a water sensor.

4. The microenvironment of claim 2, wherein the processor is configured to display the dynamic image in response to detecting the fault with the sensor.

5. The microenvironment of claim 1, wherein the computer-readable medium is encoded with plurality of dynamic images, each of the plurality of dynamic images showing the performance of a different task with respect to the microenvironment.

6. The microenvironment of claim 4, wherein the processor is configured to select the dynamic image from the plurality of dynamic images prior to displaying the dynamic image, wherein the selected dynamic image shows a corrective action that needs to be performed for the microenvironment.

7. A method of conveying user instructions for a microenvironment comprising:
accessing a dynamic image from a computer-readable medium; and
displaying the dynamic image on a display screen communicatively connected to the microenvironment, where the dynamic image comprises a representation of an action performed by a clinician with respect to the microenvironment.

8. The method of claim 7, wherein the dynamic image comprises an animated dynamic image.

9. The method of claim 8, wherein the animated dynamic image comprises a schematic representation of a character performing an action.

10. The method of claim 9, wherein the animated dynamic image comprises a cartoon character performing the action.

11. The method of claim 7, wherein the dynamic image comprises a video of an actor performing an action.

12. The method of claim 7, wherein the dynamic image comprises a representation of a clinician performing a maintenance action on the microenvironment.

13. The method of claim 12, wherein the dynamic image comprises a representation of a clinician adding water to a water tank of a humidifier.

14. The method of claim 7, wherein the dynamic image comprises a representation of a clinician adjusting a control to regulate an environmental factor within the microenvironment.

15. The method of claim 7, wherein the dynamic image comprises a demonstration showing how to set-up the microenvironment for use with an infant.

16. The method of claim 7, wherein the dynamic image comprises a demonstration showing how to admit an infant to the microenvironment.

17. A method of conveying user instructions for a microenvironment comprising:
detecting that a parameter of the microenvironment is outside of a target range;
selecting a dynamic image with a processor from a plurality of dynamic images stored in a computer-readable medium, wherein the selected dynamic image comprises a representation of an action to adjust the parameter in the back into the target range; and
displaying the dynamic image on a display screen.

18. The method of claim 17, wherein said detecting the parameter comprises detecting at least one of temperature, humidity, and gas level.

19. The method of claim 17, wherein the dynamic image comprises a representation of a clinician changing a setting on the microenvironment to adjust the parameter that is outside of the target range.

20. The method of claim 19, wherein the dynamic image comprises a representation of a clinician adjusting the microenvironment to raise the temperature within the microenvironment.

21. The method of claim 17, wherein said detecting the parameter comprises detecting that a maintenance action for the microenvironment needs to be performed.

22. The method of claim 21, wherein the dynamic image comprises a representative of a clinician performing the maintenance action.
